(19) United States
(12) Patent Application Publication
(10) Pub. No.: US 2025/0344711 A1
(43) Pub. Date: Nov. 13, 2025

(54) TCM COUGHING TEA METHOD AND COMPOSITION

(71) Applicant: Maishen Inc., Santa Clara, CA (US)

(72) Inventors: Dalong Zhang, Santa Clara, CA (US); Xinghe Chen, Santa Clara, CA (US)

(73) Assignee: Maishen Inc., Santa Clara, CA (US)

(21) Appl. No.: 18/660,152

(22) Filed: May 9, 2024

(51) Int. Cl. A23F 3/18; A23F 3/40; A23L 2/56; A23L 2/58; A23L 2/60; A23L 2/66; A23L 2/72

(52) U.S. Cl. CPC A23F 3/18; A23F 3/405; A23L 2/56; A23L 2/58; A23L 2/60; A23L 2/66; A23L 2/72

(57) ABSTRACT

A method and composition to extract of several processed herbal medicinal plants and an herbal tea composition for ingestion which contains the extract. The functional herbal extraction method and composition is used to relieve the symptoms of cough and throat discomfort. This composition creates a synergy between different ingredients that works to suppress cough, white phlegm, and sore throat. The composition comprises of Cassia bark tree twig, Coltsfoot flower, Tetarian aster, Catepillar fungus, Dried mandarin peel, Fritilaria cirrhosa, Muskroot, Pumex preparata, Isatis root, Dandelion, Puffball, Almonds, Pinellia ternata, Gypsum, and Astragalus. The effectiveness of the herbal tea is at least partially dependent on the desired means of preparation and administering the composition.

### FIELD OF THE INVENTION

The present invention relates generally to a cough relief herbal beverage method and composition. Further, the present invention relates to an herbal method and composition that balances the circulation of Qi and blood, balancing the lung cold and lung heat, thereby reducing phlegm and relieves cough, through a unique method of preparing a composition consisting of the following herbs in varying weight percentages including: Cassia bark tree twig, Coltsfoot flower, Tatarian aster, Caterpillar fungus, Dried mandarin peel, Fritillaria cirrhosa, Muskroot, Pumex preparata, Isatis root, Dandelion, Puffball, Almonds, Pinellia ternata, Gypsum, Astragalus.

### BACKGROUND OF THE INVENTION

Cough is the most common reason for patients to seek medical treatment in the outpatient setting. Cough can be a warning sign of respiratory or non-respiratory diseases. According to previous clinical manifestations, dry cough symptoms generally appear in the late stages of a cold. It is commonly believed that gastroesophageal reflux, post-nasal drip, or asthma can cause chronic cough. In Traditional Chinese Medicine (TCM), when the lungs are attacked by cold or heat, the alveolar mucosal tissue spasms. This leads to spasmodic cough in the bronchus, accompanied by sticky sputum or no sputum, and the symptoms lasts about a week. The current symptoms of dry cough are different from those in the past. Most patients with dry cough have a history of COVID-19 or influenza, and a few have vaccine sequelae. The duration of dry cough for those suffering from COVID-19 or influenza usually lasts for more than 3-4 weeks, and some patients may experience dry cough symptoms for months or even years. This kind of dry cough is called viral dry cough. The main reason why the currently popular dry cough symptoms cannot be treated with traditional cough syrups is that the causes of previous coughs and the currently popular dry coughs are different, and the classification of dry coughs is different.

Covid-19 virus often remains dormant in the body, and in some cases, it is possible that Covid latent viruses are reactivated, causing Covid symptoms amongst patients. When these viruses remain dormant in the patient's body, and the patient's immunity declines or the weather changes, these viruses will become active. At the baseline, the patient has constant dry cough and rarely produces sputum; and if the patient's immunity begins to increase, the anti-viral ability begins to increase, and the virus is in a dormant state, tentatively determined to be below the 60-point level, then the symptoms of dry cough will weaken or even disappear. In this way, dry cough symptoms recur, and the patient is constantly disturbed.

It is widely recognized in Traditional Chinese Medicine (TCM) that cough is a symptom with which the lung reacts to a form of irritation, which is considered as a ‘lung counterflow qi.’ In TCM, the lungs disperse and regulate Qi. Their proper functioning is dependent on the harmonious relationship with other organs, particularly the spleen and kidneys, which can sometimes be disrupted by external pathogens or internal disharmonies. Phlegm in the lung is created through damp obstruction of the middle jiao, arising from inadequate functioning of the spleen. Phlegm stagnation in the lung leads to failure of lung qi to descend, coughing cough, dyspnea, or wheezing, stifling sensations in the chest, and profuse sputum.

As a method to treat cough symptoms, TCM traditionally teaches that clam and snow pear soup can cure cough symptoms but this is not the case. The reason is that the sugar in fruits or desserts will accelerate the reproduction rate of dry cough viruses, and aggravate dry cough. Some customers will choose “Golden Throat” to treat throat pain, but since it contains sugar, the results are inconclusive. Sugar will accelerate the reproduction rate of dry cough viruses and cause throat pain to worsen. If we go back to the theory of Traditional Chinese Medicine (TCM), eating sugar will damage the spleen, the spleen will generate dampness, and the dampness will generate phlegm. This explanation differs from biochemical theory, but the result is the same.

### SUMMARY OF THE INVENTION

This invention generally relates to extracts of several processed herbal medicinal plants and an herbal tea composition for ingestion which contains the extract. The invention's composition is used to relieve the symptoms of cough and throat discomfort. This composition creates a synergy between different ingredients that works to suppress cough, white phlegm, and sore throat.

The invention is due, in part, to the unexpected finding that administration of the present invention's composition relieves cold cough and dry cough, diagnosable conditions in TCM. TCM diagnose cold, hot, dry, wet coughs by examining patients' pulse speed, tongue coating, color of the sputum, and color of the nasal mucus. The present invention's composition is at least used to relieve symptoms of cold cough and dry cough.

In a preferred embodiment of the present invention, the composition includes Cassia bark tree twig, Coltsfoot flower, Tatarian aster, Caterpillar fungus, Dried mandarin peel, Fritillaria cirrhosa, Muskroot, Pumex preparata, Isatis root, Dandelion, Puffball, Almonds, Pinellia ternata, Gypsum, and Astragalus. The effectiveness of herbal tea is at least partially dependent on the desired means of preparation and administering the composition.

In another preferred embodiment of the present invention, the composition includes Cassia bark tree twig, Coltsfoot flower, Tatarian aster, Caterpillar fungus, Dried mandarin peel, Fritillaria cirrhosa, Muskroot, Pumex preparata. The effectiveness of herbal tea is at least partially dependent on the desired means of preparation and administering the composition.

In one embodiment, the therapeutically effective amount comprises from between about 1 mg to about 14000 mg/day.

In a preferred embodiment of the present invention, the therapeutically effective amount comprises from between about 330 mg to 660 mm/day.

In a preferred embodiment of the present invention, the therapeutically effective amount is a dosage regiment of half of a bottle in the morning, and half of a bottle in the evening, wherein each bottle comprises about 330 mg of the composition.

In a preferred embodiment of the present invention, the therapeutically effective amount is a dosage regiment of one bottle in the morning, and one bottle in the evening, wherein each bottle comprises about 330 mg of the composition.

In one embodiment, the administration to the subject occurs between about 30 minutes to about 1 hour after consuming food.

In another embodiment, the composition is added with equal parts of water and heated over the stovetop or microwave, then administered to the subject.

In another preferred embodiment of the present invention, a method to brew an herbal beverage product has the following steps: the grinding together of all these aforementioned ingredients to obtain a dispersion of finely ground brewing particles, adding an aqueous solution to the ground particles, heating the aqueous solution from about room temperature to about boiling temperature, reduction of the aqueous liquid by simmering, filtering the aqueous liquid to obtain the first extract, adding an aqueous solution to the remaining solids of the first extract, heat the aqueous solution containing solids from the extract from about room temperature to about boiling temperature, reduction of the aqueous solution contain the first extract by simmering, filtering the aqueous solution containing solids from the first extract to obtain the second extract, combining both extracts with Caterpillar Fungus to create a third extract, reducing the third extract with a condensing machine.

In another preferred embodiment of the present invention, a method to brew an herbal beverage product has the following steps: the grinding together of all these aforementioned ingredients to obtain a dispersion of finely ground brewing particles, adding an aqueous solution to the ground particles, heating the aqueous solution from about room temperature to about boiling temperature, reduction of the aqueous liquid by simmering, filtering the aqueous liquid to obtain the extract.

In another preferred embodiment of the present invention, the composition is administered in at least one of the following ways: oral, topical, suppository, intravenous, intradermic, intramuscular, and intraperitoneal.

In another preferred embodiment of the present invention, the composition includes at least one member selected from the group consisting of: a tablet, an orally disintegrating tablet, a pill, a dripping pill, a lozenge, a capsule, a cream, a granule, a suppository, and an oral liquid.

In another preferred embodiment of the present invention, the composition consists of a plurality of herbal ingredients prepared through processing methods, extraction methods, and purification methods.

In another preferred embodiment of the present invention, the processing methods include at least one member selected from the group consisting of: washing, steaming, extracting, roasting, herb frying, salt frying, honey frying, wine frying, earth frying, vinegar frying, calcining drying, beating, and grinding.

In another preferred embodiment of the present invention, the extraction methods include at least one member selected from the group consisting of: soaking, heating, steaming, evaporation, compressing, and solvent extraction with at least one of the following: water, alcoholic solvents mixed with water, petroleum ether, hexane, diethyl amine, diethyl ether. cyclohexane, tert-butyl alcohol, isopropanol, Acetonitrile, acetone, ethanol, methyl isobutyl ketone, isobutyl alcohol, 1-propanol, methyl ethyl ketone, 2-butanol, isoamyl alcohol, 1-butanol, diethyl ketone, 1-octanol, p-xylene, m-xylene, toluene, dimethoxyethane, benzene, butyl acetate, 1-chlorobutane, tetrahydrofuran, ethyl acetate, o-xylene, hexamethylphosphorus triamide, 2-ethoxyethyl ether, N,N-dimethylacetamide, diethylene glycol dimethyl ether, N,N-dimethylformamide, 2-methoxyethanol, pyridine, propanoic acid, 2-methoxyethyl acetate, benzonitrile, 1-Methyl-2-pyrrolidinone, hexamethylphosphoramide, 1,4-dioxane, acetic acid, acetic anhydride, dimethyl sulfoxide, chlorobenzene, ethylene glycol, diethylene glycol, propylene carbonate, formic acid, 1,2-dichloroethane, glycerin, carbon disulfide. 1,2-dichlorobenzene, methylene chloride, nitrometbane, 2,2,2-trifluoroethanol, chloroform, 1,1,2-trichlorotrifluoroethane, carbon tetrachloride, and tetrachloroethylene.

In another preferred embodiment of the present invention, the purification methods include at least one member selected from the group consisting of: column separation, solvent partition, evaporation, and solvent precipitation.

One objective of the present invention is to provide an herbal composition that suppresses and relieves cough symptoms.

Another objective is to provide an herbal composition that consists of easily available herbal ingredients.

Other systems, devices, methods, features, and advantages will be or become apparent to one with skill in the art upon examination of the following drawings and detailed description. It is intended that all such additional compositions, systems, methods, features, and advantages be included within this description, be within the scope of the present disclosure, and be protected by the accompanying claims and drawings.

### DETAILED DESCRIPTION OF THE INVENTION

Aspects of the invention are disclosed in the following description directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiments of the invention,” “embodiments” or “invention” do not require that all embodiments of the invention include the discussed feature, advantage or mode of operation.

The following description directed to the medicinal properties of individual herbs and mixture of herbs is based, at least in part, on the teachings of Traditional Chinese Medicine (“TCM”). As such, the properties attributed to the individual herbs and mixtures of herbs set forth herein are done so in a non-limiting manner. Any evidence to the contrary based on other understandings or changes in understanding regarding TCM, or past and future scientific research will not operate to affect the operability of embodiments set forth and claimed herein, as will be readily recognized by one having ordinary skill in the art.

The invention is due, in part, to the unexpected finding that administration of the present invention's composition relieves cold cough, a diagnosable condition in TCM. If the patient's pulse speed is about 70 times a minute, combined with cough symptoms, the condition is diagnosed as a cold cough. Cold cough can also be diagnosed by looking at the color of the tongue coating. White tongue coating or no tongue coating indicates cold cough. The color of the sputum also indicates cold or hot cough. White phlegm or no phlegm indicates cold cough. Lastly, the color of the nasal mucus indicates cold cough or hot cough. If the phlegm is white or there is no phlegm, combined with cough symptoms, the condition is a cold cough. The present invention's composition is at least therapeutically effective in treating cold cough and dry cough.

For patients with dry cough, they are usually presented with tiredness, sleepiness, fatigue, weakness, lack of energy, and lack of concentration. This is also a typical symptom of the sequelae of COVID-19. For patients with dry cough, replenishing qi and blood, and restoring physical strength will improve immunity and reduces dry cough symptoms. Even when the symptoms of dry cough are cured, it will take at least three months for the patient to regain his previous physical strength. To completely eliminate dry cough, TCM should aim to regulate the spleen and stomach, strengthen the kidneys and replenish deficiency, moisten the lungs and replenish qi, strengthens the heart and replenish the yang, replenish Qi and blood. Especially for patients who are physically weak, accompanied by loss of appetite, or even eating less, they should focus on replenishing Qi. For patients who have developed chronic pneumonia or Cor pulmonale and rely on oxygen tanks, TCM should aim to increase the regeneration capacity of alveolar cells and get rid of oxygen cylinder supply as soon as possible.

The composition of the present invention consists of the following herbal ingredients mixed in varying weight percentages: Cassia bark tree twig, Coltsfoot flower, Tatarian aster, Caterpillar fungus, Dried mandarin peel, Fritillaria cirrhosa, Muskroot, Pumex preparata, Isatis root, Dandelion, Puffball, Almonds, Pinellia ternata, Gypsum, and Astragalus. The herbal ingredients aforementioned combine to create a synergy to suppress cough symptoms, improve the circulation of Qi and blood, and balances the forces of Yin and Yang. The present disclosure provides a novel mixture of the ingredients, including unique processing, extraction, and purification methods for optimizing efficacy of the herbal ingredients. The effectiveness of the composition is at least partially dependent on the desired means of preparation and administering the composition.

The individual herbal ingredients are efficacious for nourishing the lung, regulating water in the physical body to reduce or eliminate phlegm. Those skilled in the art will recognize that TCM teaches that the lung is the primary organ that regulates the qi around the body. If the lung is obstructed, so is the qi that circulates in the body. The lung serves four functions of the qi, ascending, descending, inwards and outwards. The lung is an important organ to regulate both qi and blood.

According to the theories of TCM, the spleen produces phlegm and the lung stores phlegm. Cough, profusion of sputum and lung qi reversal occurs when the spleen does not properly dissolve dampness. The herbal composition works to improve balance between wet and dry to reduce and eliminate phlegm.

In a TCM clinical research setting, the composition of the present invention was administered to patients with cold cough and dry cough, about 95% to 98% of the patients experience the relief of cough symptoms within two to three weeks. In one study, an elementary school student was experiencing a cold and exhibited symptoms of cough and white phlegm. During TCM pulse diagnosis and tongue diagnosis, it was found that the lung meridian is weak and blocked, the student was experiencing dry cough, which worsened between 11 pm and 2 am. The student was administered with a total of 10 bottles of the composition, 2 bottles a day, and the symptoms were relieved.

In another case study, a TCM patient was complaining of swelling and pain in the right chest, caught a cold and developed fever, dizziness, tiredness, weakness, and tinnitus. The patient also had cold hands. The symptoms of cough showed dry cough, with white phlegm and the cough worsened at night. The pulse diagnosis showed that the lung and kidney meridians were weak and liver meridian was blocked. The patient was administered with a total of 7 bottles of the composition, 2 bottles a day, and the symptoms were relieved.

### Cassia Bark Tree Twig (Guizhi)

As used in the present disclosure, one of the herbal ingredients is Cassia Bark Tree Twig, known as Guizhi in Mandarin. In TCM Guizhi is categorized as a wind-cold releasing herb. Guizhi is acrid, sweet and warm, and it exerts a diaphoretic function to release the exterior, the area between the muscles and the skin. Guizhi warms yang to eliminate water or phlegm stagnation and warms yang in the chest to reduce painful obstruction of the chest.

### Coltsfoot Flower (Kuan Dong Hua)

Another herbal ingredient is Coltsfoot flower, known as Kuan Dong Hua in mandarin. Kuan Dong Hua is categorized as a coughing/wheezing-releasing-herb. Kuan Dong Hua is used in TCM to dissolve phlegm, stops cough due to lung cold, lung heat, or lung yin deficiency. It is most effective for treating cough due to cold attacking the lung, or chronic cough with blood-streaked sputum. When combined with appropriate herbs, Kuan Dong Hua treats upper respiratory infection, influenza, and a wide range of coughing disorders, including cold or hot, exterior or interior, and excess or deficient conditions. In a clinical study, extract of Kuan Dong Hua (equivalent to 6 grams of herb) given three times daily provided marked relief in treating 36 asthma patients. The preparation, however, was ineffective for treating acute and severe onset of an asthma attack.

### Tatarian Aster (Ziwan)

Another herbal ingredient is Tatarian Aster, known as Ziwan in mandarin. Ziwan is categorized as a cough/wheezing-releasing-herb, used in TCM to dissolve phlegm and stops cough due to wind-cold, wind-heat, or lung deficiency. Ziwan is warm but not hot, and moistening. Zi Wan has an antibiotic influence against E coli, Bacillus dysenteriae, Bacillus proteus, Salmonella typhi, Bacillus paratyphosus, Pseudomonas aeruginosa, Vibrio cholerae, and some dermatophytes and influenza viruses. Zi wan has show antineoplastic effects, preliminary inhibitory effects on the growth of cancer cells in mice.

### Caterpillar Fungus (Dong Chong Xiao Cao)

Another herbal ingredient is Caterpillar fungus, Dong Chong Xiao Cao in mandarin. Dong Chong Xiao Cao is categorized as a yang-tonifying herb, used in TCM to tonify kidney Yang and augments Jing (essence) and to tonify the lung, stops bleeding and dissolves phlegm. Dong Chong Xiao Cao is ideal for convalescing patients or those who are extremely weak, with spontaneous sweating. Dong Chong Xiao Cao also helps to arrest cough, dispel sputum, and stop bleeding. It is moderate in its effect to suppress cough, suitable for chronic cough caused by yin or qi deficiency.

### Dried Mandarin Peel (Chenpi)

Another herbal ingredient is dried mandarin peel, known as Chenpi in mandarin. Chenpi is categorized as a Qi-regulating herb, used in TCM to regulate Qi, adjusts the middle Jiao, regulates spleen and stomach Qi, dissolves phlegm, and relieve cough.

### Fritillaria Cirrhosa (Chuanbeimu)

Another herbal ingredient is Fritillaria Cirrhosa, known as Chuanbeimu, in mandarin. Chuanbeimu is categorized as a Phlegm-resolving and coughing/wheezing relieving herb, used in TCM to dissolve phlegm and stops coughing, clear heat and to disperse nodules. Chuanbeimu is cool and sweet, moistens the lung and dissolves phlegm. It is mostly used for chronic dry cough with scanty difficult-to expectorate sputum, either with or without blood. Chuanbeimu has a marked antitussive effect in rats. The maximum effect was reached 30 minutes after oral administration of herbs, and the effect lasted up to 2 hours.

In a clinical study, equal portions of Chuanbeimu and Kuan Dong Hua were ground into powder and given to children for the treatment of whooping cough in children. The dosage was 1 gram per day for infants under 1 year of age, and adjusted accordingly for children over 1 year of age. Out of 56 cases, 51 showed complete recovery, 4 showed moderate improvement, and 1 had no response.

### Muskroot (Tiankuizi)

Another herbal ingredient is Muskroot, known as Tiankuizi in mandarin. Tiankuizi is categorized as heat-clearing and toxin-eliminating herb, used in TCM for clearing heat and eliminating toxins, dispersion of stagnation and reduces swelling. Tiankuizi resolves and reduces masses characterized by the presence of heat and toxins.

### Pumex Preparata (Haifushi)

Another herbal ingredient is Pumex Preparata, known as Haifushi in mandarin. Haifushi is categorized as phlegm-resolving herb, used in TCM for clearing the lung, dissolving phlegm, softens hardness and dissipate nodules, regulates water circulation to treat dysuria.

### Isatis Root (Ban Lan Gen)

Another herbal ingredient is Isatis root, known as Ban Lan Gen in mandarin. Ban Lan Gen can be harvested from the leaf or the root, categorized as heat-clearing and toxin-eliminating herb, used in TCM for clearing heat, eliminating toxins, cooling blood, and benefits the throat. Isatis root detoxifies various poisons, improves the eyes and ears, benefits the five internal organs and regulates the six internal organs. It is commonly used to clear heat and toxins from both the exterior and the interior and regulates the qi accumulation in the meridians.

Ban Lan Gen is commonly used to treat encephalitis B, hepatitis, chickenpox, epidemic parotitis, and viral dermatitis including herpes simplex, herpes zoster, pityriasis rosea and flat warts. It pharmacological effects are antibiotic, and immunostimulant. Ban Lan Gen is sometimes incorporated into herbal formulas for treatment of upper respiratory tract infection. In one clinical study, 46 patients with acute tonsillitis were treated with an herbal formula including Isatis root, with complete recovery in 40 patients, and moderate improvement in 6 patients.

### Dandelion (Pu Gong Ying)

Another herbal ingredient is Dandelion, known as Pu Gong Ying in mandarin. Pu Gong Ying is categorized as heat-clearing and toxin-eliminating herb, used in TCM for clearing heat and eliminating toxins from both the exterior and the interior. External heat toxins are characterized by sores, lesions, and ulcerations. Internal heat and toxins are characterized by abscesses, nodules, intestinal abscesses, breast lumps parotitis and tonsillitis. Pu Gong Ying enters the liver channel, makes this herb an excellent method to treat the beginning stages of breast abscess or lumps. Sometimes Pu Gong Ying is used to treat soreness and swelling of the throat, used for its antiseptic properties, and used to eliminate damp-heat.

### Puffball (Ma Bo)

Another herbal ingredient is Puffball, or the fruiting portion of the Puffball, known as Ma Bo in mandarin. Ma Bo is categorized as a heat-clearing and toxin-eliminating herb, used in TCM for clearing the lung, benefits the throat, and eliminating toxins. Ma Bo enters and treats the lung by entering the lung, clears heat and eliminates toxins, to reduce cough, sore or swollen throat and loss of voice. Clinical studies and research show Ma Bo can stop bleeding from the oral cavity.

### Almonds

Another ingredient is almonds. It is known in TCM, coughing produces a thundering sound, laryngeal numbness, lowering of breath, and produces shortness of breath. decoction of Tianmen Dong can moisten the heart and lungs, moisten the sound and Qi; remove lung heat and cure the above symptoms. Jiao wind and dryness can relieve chest and diaphragm Qi reversal, and moisturize the large intestine for qi secretion, cough with cold and heat, long-term lung Qi problem.

### Pinellia Ternata (Ban Xia)

Another ingredient is Pinellia Ternata, known as Ban Xia in mandarin. Ban Xia is categorized as a phlegm-resolving and coughing/wheezing-relieving herb, used in TCM for drying dampness, dissolving phlegm, redirecting abnormally rising stomach qi, relieves nausea and vomiting, dissipates nodules and disperses stagnation, and treats sores, skin ulcerations and carbuncles. Ban Xia is acrid, warm, and drying, suitable for entering the spleen and lung to eliminate phlegm accumulations.

Qin Ban Xia, is a TCM herbal medicine made from soaking Ban Xia in water and cooked with alumen to reduce its acrid and drying nature, is more suitable for infants, the elderly, and weaker patients who have accumulation of dampness and phlegm. “Zhu Li Ban Xia,” processed with Zhu Li a TCM herbal medicine processed with Zhu Li (Succus Bambusae) to greatly reduce its warm and drying nature, suitable for nausea caused by stomach heat, cough with yellow copious sputum from lung heat, or post-stroke conditions with hot phlegm.

### Gypsum (Shi Gao)

Another herbal ingredient is Gypsum, known as Shi Gao in mandarin. Shi Gao is categorized as heat-clearing and fire-purging herbs, used in TCM to clear heat, sedates fire, relieves irritability and quenches thirst, clears lung heat, clears stomach heat and channel, clears heat and promotes healing from sores, burns, and eczema. Gypsum has low solubility than other herbs so it is common to use in larger dosage. However, if gypsum is administered orally, the dosage is lowered since solubility is no longer applicable.

Shi Gao reduces heat due to stroke, dyspnea in the heart, and asthma, wheezing and sore throat. The pharmacological effects of Shi Gao is antipyretic, immunostimulant, and shown to facilitate the passage of bile, shorten coagulation time, promote diuresis, and reduce spontaneous intake of water in laboratory mice. According to one report, 200 patients with high fever were treated with an herbal decoction (120 grams of Shi Gao, 3 grams of Ma Huang, and 3 grams of Guizhi. Of 200 patients, 181 showed a reduction in body temperature.

### Astragalus (Huang Qi)

Another herbal ingredient is Astragalus, known as Huang Qi in mandarin. Huang Qi is categorized as Qi-tonifying herb, used in TCM to tonify Qi and raises Yang, tonifies Wei (defensive) Qi, consolidates the exterior, promotes the discharge of pus, and generates flesh, regulates water circulation, reduces edema, relieves numbness and pain, and treats Xiao Ke (wasting and thirsting syndrome). In TCM, Huang Qi is used to treat manifestations of disease in the respiratory and digestive systems, and treating symptoms of cough, wheezing, shortness of breath, profuse white and watery sputum. Huang Qi enters and tonifies lung and spleen channels.

Huang Qi's pharmacological effects are immunostimulant, hematopoietic, metabolic, effect on cAMP and cGMP, renal, antihypertensive, hepatoprotective, antibiotic, sedative and analgesic. In one study, 540 patients with history of frequent common colds and influenza were divided into two groups that received 5 grams of Huang Qi three times daily, and 15 grams of Huang Qi every other day. Both groups showed they had 2.7 times lower risk of infection and a shortened duration of infection. In another study, patients with histories of chronic bronchitis, bronchial asthma, and allergic rhinitis, were given 15 grams of Huang Qi and 10 grams of Da Zao (Fructuc Jujubae), in a form of an herbal tea, taken twice daily, showed improvement. In another study, patients with asthma and cough, were injected (equivalent to 1 gram of dried herb) into Zusanli (ST 36) twice a week, for three months per course of treatment. For a total of 3 to 4 courses of treatment, with 2 weeks of rest between each course. Out of 41 patients, there was significant improvement in 85.4% and moderate improvement in 56.1%.

The extract of each of the above identified herbs is prepared and decocted by traditional procedures known in the art which includes boiling, filtering, and forming concentrates.

In a preferred embodiment of the present invention, a method to brew an herbal beverage product has the following steps: the grinding together of all these aforementioned ingredients to obtain a dispersion of finely ground brewing particles, adding an aqueous solution to the ground particles, heating the aqueous solution from about room temperature to about boiling temperature, reduction of the aqueous liquid by simmering, filtering the aqueous liquid to obtain the first extract, adding an aqueous solution to the remaining solids of the first extract, heat the aqueous solution containing solids from the extract from about room temperature to about boiling temperature, reduction of the aqueous solution contain the first extract by simmering, filtering the aqueous solution containing solids from the first extract to obtain the second extract, combining both extracts with Caterpillar Fungus to create a third extract, reducing the third extract with a condensing machine.

To form the composition of the present invention in one embodiment, the extracted concentrate of each herb is mixed according to the following measurements: Cassia bark tree Twig, about 10 to 20 percent by dry weight, Coltsfoot flower, about 5 to 15 percent by weight, Tatarian aster, about 5 to 15 percent by weight, Caterpillar fungus, about 0.5 to 1.5 percent by weight, Dried mandarin peel, about 10 to 20 percent by weight, Fritillaria Cirrhosa, about 15 to 25 percent by weight, Muskroot, about 10 to 20 percent by weight, Pumex Preparata, about 7 to 21 percent by weight.

To form the composition of the present invention in another embodiment, the extracted concentrate above is combined with the extracted concentrate of each herb mixed according to the following measurements: Isatis root, about 11 to 21 percent by weight, dandelion, 6 to 16 percent by weight, puffball, 5 to 13 percent by weight, almonds, 6 to 16 percent by weight, Pinellia ternate, 6 to 16 percent by weight, gypsum, 11 to 16 percent by weight, astragalus, 12 to 34 percent by weight.

The composition of the present invention is for ingestion in the form of a tea, liquid beverage, tablet, capsule, powder, or soup. Conventionally known methods known in the art are used to prepare the composition in the different forms. The form in which the composition is prepared does not significantly affect its efficacy. The ideal form of the composition is an herbal tea. For mild symptoms, ½ of the preferred quantity should be consumed in the morning, and ½ of the preferred quantity should be consumed in the evening. The ideal form of the composition, in an herbal tea, is to mix with 1 part water and 1 part composition, heated over the countertop or microwave, and consumed after a meal. The composition should be taken daily on a regular basis to obtain maximum benefits, until the cough symptom alleviates.

While a preferred embodiment of the invention has been described and illustrated for purposes of clarity and example, it should be understood that many changes, substitutions and modifications to the described embodiment will be apparent to those having skill in the art in light of the foregoing disclosure without departing from the scope and spirit of the present invention which is defined by the claim which will follow.

1. (canceled)

2. (canceled)

3. (canceled)

4. (canceled)

5. (canceled)

6. (canceled)

7. An herbal composition for preparing an herbal tea for suppression of cough symptoms, comprising therapeutically effective amounts of the following herbal ingredients, wherein the amounts are expressed as percentages by weight of the total composition: from about 2% to about 15% by weight of Cassia bark tree twig, from about 2% to about 15% by weight of Coltsfoot flower, from about 4% to about 25% by weight of Tatarian aster, from about 1% to about 3% by weight of Caterpillar fungus, from about 4% to about 25% by weight of Dried mandarin peel, from about 2% to about 15% by weight of Fritillaria Cirrhosa, from about 4% to about 25% by weight of Muskroot, from about 4% to about 25% by weight of Pumex Preparata.
Wherein the total combined weight of the listed ingredients equals 100% of the composition, and wherein the composition is effective to reduce cough frequency or severity in a subject in need thereof.

8. The composition of claim 7, wherein the composition is administered in at least one of the following ways: oral, topical, suppository, intravenous, intradermic, intramuscular, and intraperitoneal.

9. The composition of claim 7, wherein the composition includes at least one member selected from the group comprising of: a liquid beverage, an aqueous beverage, a tablet, an orally disintegrating tablet, a pill, a dripping pill, a lozenge, a capsule, a cream, a granule, and a suppository.

10. (canceled)

11. (canceled)

12. (canceled)

13. (canceled)

14. (canceled)

15. (canceled)

16. (canceled)
